(19) United States
(12) Patent Application Publication
(10) Pub. No.: US 2014/0133800 A1
(43) Pub. Date: May 15, 2014

(54) OPTICAL SWITCH CONTROL METHOD, OPTICAL SWITCH CONTROL DEVICE, AND OPTICAL TRANSMISSION SYSTEM

(71) Applicants: Tomoyuki Hino, Tokyo (JP); Masahiro Sakauchi, Tokyo (JP); Akio Tajima, Tokyo (JP)

(72) Inventors: Tomoyuki Hino, Tokyo (JP); Masahiro Sakauchi, Tokyo (JP); Akio Tajima, Tokyo (JP)

(73) Assignee: NEC CORPORATION, Minato-ku, Tokyo (JP)

(21) Appl. No.: 14/126,492

(22) PCT Filed: Jun. 7, 2012
(86) PCT No.: PCT/JP2012/003742

§ 371 Date: Dec. 16, 2013

(30) Foreign Application Priority Data
Jun. 14, 2011 (JP) 2011-132648

(51) Int. Cl. G02B 6/35

(52) U.S. Cl. CPC G02B 6/354
USPC 385/16

(57) ABSTRACT

An optical switch control device includes a driving control unit (106) controlling a plurality of optical switches (105) which are respectively provided between a plurality of input ports (102) and a plurality of output ports (103) and respectively turn on and off the transmission of light from the plurality of input ports (102) to the plurality of output ports (103), wherein the driving control unit (106) performs a control operation of changing the optical switch (105) from an off state to an on state prior to a control operation of changing the optical switch (105) from the on state to the off state.

### TECHNICAL FIELD

The present invention relates to an optical switch control method, an optical switch control device, and an optical transmission system, and more particularly, to a method of controlling an optical switch of a matrix optical switch used in an optical transmission network, an optical switch control device, and an optical transmission system.

### BACKGROUND ART

With the rapid spread of the Internet, an optical transmission network using a Wavelength Division Multiplexing (WDM) technique capable of transmitting a large amount of traffic has been spread. In the optical transmission network, an Optical cross Connect/Reconfigurable Optical Add/Drop Multiplexer (OXC/ROADM) device or an optical add/drop device capable of switching, branching, or inserting an optical signal as light is used as an optical transmission device in order to flexibly respond to a change in demand for communication between transmission nodes. In the OXC/ROADM. device or the add/drop device, a matrix optical switch is a key component which has a connection function for switching an optical signal from an arbitrary path to an arbitrary path. In this specification, a symbol “/” in “OXC/ROADM” or “add/drop” means “or”. For example, the “add/drop device” means a device which includes at least one of an add device and a drop device.

The matrix optical switch is an optical component capable of arbitrarily connecting and switching between a plurality of input and output ports. The matrix optical switch is configured by Micro Electro Mechanical Systems (MEMS) which is a representative configuration method. In addition, various matrix optical switch configuration methods have been proposed. For example, the matrix optical switch is configured by a Planar Lightwave Circuit (PLC) which has an optical switch having 2×2 input and output ports as a component and includes an optical waveguide formed on a substrate. Here, “2×2” means “two inputs and two outputs”.

In the OXC/ROADM device or the add/drop device, the matrix optical switch is packaged or integrated together with a wavelength filter, such as an Arrayed Waveguide Grating (AWG) or a diffraction gating, and is used as a Wavelength Selective Switch (WSS). That is, the matrix optical switch has been applied as a component capable of outputting an arbitrary wavelength to an arbitrary port to the OXC/ROADM device and the add/drop device.

Patent Document 1 (Japanese Unexamined Patent Publication No. 2010-56676) discloses an example of a ROADM optical node system. FIG. 12 shows the structure of the system disclosed in Patent Document 1. As shown in FIG. 12, in the system disclosed in Patent Document 1, an optical coupler 1001 is applied to an input WDM line portion to branch light. In this system, a 1×N Wavelength Selective Switch (WSS) for drop 1002 is applied to one of the branched lines and is connected to transponders 1003. Here, “1×n” means “one input and N outputs” (N is a natural number).

FIG. 13 is a block diagram illustrating the 1×N Wavelength Selective Switch (WSS) for drop 1002. The 1×N Wavelength Selective Switch (WSS) for drop 1002 has a function of outputting an optical signal with an arbitrary wavelength to an arbitrary output port among n output ports (n is a natural number). That is, in FIG. 13, a signal which is branched from the optical coupler 1001 and is then input from a port A1 is demultiplexed by an AWG 1101 and is then divided between ports B1 to Bn for respective wavelengths. Then, a matrix optical switch 1102 forms an optical path to a desired transponder 1003.

In FIG. 12, an N×1 Wavelength Selective Switch (WSS) for add 1004 is applied to the other branched input WDM line portion and is connected to an output WDM line. FIG. 14 is a block diagram illustrating the N×1 Wavelength Selective Switch (WSS) for add 1004. As shown in FIG. 14, the N×1 Wavelength Selective Switch (WSS) for add 1004 has a function of selecting arbitrary wavelengths from among the respective optical signals which are input from the transponders 1003 through n input ports, performs wavelength division multiplexing, and outputs the result from the output port. Here, “N×1” means “N inputs and one output”.

That is, a matrix optical switch 1102 forms an optical path such that the signals transmitted from the WDM line and the transponders 1003 are combined with each other into a predetermined wavelength at a port A1 of an AWG 1101 in FIG. 14. The transponder 1003 is a device with a light receiving and transmitting function which receives a client signal and is connected to the WDM line portion. In FIG. 14, the transponder 1003 is separated into an add unit and a drop unit. However, in general, the add unit and the drop unit are formed integrally.

Patent Document 2 (Japanese Unexamined Patent Publication No. 2004-153307) discloses an example of a two-dimensional MEMS based matrix optical switch. FIG. 15 shows the structure of a two-dimensional MEMS based matrix optical switch 2001 disclosed in Patent Document 2. Here, the MEMS is a device obtained by integrating, for example, a mechanical component, a sensor, an actuator, and a circuit onto a silicon substrate or a glass substrate using a semiconductor process, such as photolithography or etching. In many cases, the MEMS which is used as an optical switch in optical communication has a structure in which a mechanical component, such as a mirror, is integrated onto a silicon substrate. Mirror elements 2002 of the MEMS are provided at the intersections of input and output ports (2003 and 2004) (IN1 to IN5 and OUT1 to OUT5) and are turned on and off under the control of an external device. In FIG. 15, each mirror element 2002 in an on state is represented in black and each mirror element 2002 in an off state is represented in white. A pair of input and output ports (2003 and 2004) is connected to each other when one MEMS mirror element 2002 is turned to the on state.

FIG. 16 is a diagram illustrating a structure in which the two-dimensional matrix optical switch 2101 disclosed in Patent Document 2 is implemented by quartz-based optical waveguides. This is a matrix optical switch having a plurality of 2×2 optical switches 2102 as components. This type of optical switch generally uses a change in refractive index due to heat application for switching. A switch change operation is an operation of changing 2×2 cross or bar states and is the same as the operation of controlling the turning on and off of the mirror element shown in FIG. 15. During the communication in which the turning on and off of the matrix optical switch disclosed in Patent Document 1 or Patent Document 2 is controlled, serial communication is generally used for the ease of communication. That is, a plurality of optical switches forming the matrix optical switch are sequentially processed and driven.

However, in the matrix optical switch disclosed the above-mentioned patent documents, since a large number of optical signals are treated at the same time, crosstalk occurs or stray light is generated. The crosstalk is an interference of an optical signal with another optical signal and causes the deterioration of signal quality.

The stray light is a phenomenon which generally becomes a problem in a waveguide-type optical device and in which an optical signal leaks to a portion (a clad portion or a substrate) which does not guide the optical signal and the leakage light affects the signal. There are approaches to solve the problems of the crosstalk and the stray light. For example, there are countermeasures against the respective problems to be creative with an optical coupling system and to form a light-shielding via in the waveguide. However, as the number of signals treated increases, the influence of these problems becomes more significant. As such, since the matrix optical switch provided in the optical cross connect device and the optical add/drop device treats a very large number of signals, it is very important to take measurements to solve the problems of crosstalk or stray light.

Patent Document 3 (Japanese Unexamined Patent Publication No. 2002-262318) discloses a technique for solving these problems. Patent Document 3 discloses that blocking means for blocking an optical signal in a stage prior to an input port for a path switching period is added in order to suppress the crosstalk of a three-dimensional MEMS based matrix optical switch.

FIG. 17 is a diagram illustrating crosstalk during switching in Patent Document 3. FIG. 17 shows an example of crosstalk during switching in a 4×4 optical switch 2301. For example, when an optical path P2 of the optical paths P1 and P2 which are operating is switched to another switch port (optical path P3) in order to recover the fault of the transmission path, an optical signal leaks to signal light 2303 traveling through another optical path P1 which is operating during switching, which causes crosstalk 2304 in an optical regeneration unit.

Patent Document 3 discloses that blocking means for blocking an optical signal in a stage prior to the input port of the optical switch 2301 for the path switching period is added in order to prevent the leakage of the optical signal. As the blocking means, the following is given as an example: an optical switch element is used to transmit or block an optical signal in response to a control signal; the gain of an optical amplifier is controlled to transmit or block an optical signal; a light source is turned on and off in response to a control signal; or the angle of a movable mirror is controlled to transmit or block an optical signal. The three-dimensional matrix optical switch can increase the number of ports, as compared to a two-dimensional switch, but has a more complicated structure than the two-dimensional switch.

### DISCLOSURE OF THE INVENTION

In the above mentioned crosstalk suppression method for the optical path switching period disclosed in Patent Document 3, since the blocking means should be newly added, there is a problem in that the structure becomes complicated. That is, in the method in which the optical switch element is used as the blocking means and the optical switch is turned off only for the switching period in the matrix optical switch, new optical switch elements corresponding to the number of ports are needed as the blocking means and a circuit for controlling the optical switch elements as the blocking means is also needed. This holds for the case in which the gain of the optical amplifier, the turning on and off of the light source in response to the control signal, or the turning on and off of the transmission of the optical signal by the control of the movable mirror angle is used as the blocking means.

An object of the invention is to provide an optical switch control method, an optical switch control device, and an optical transmission system capable of solving the above-mentioned problem of complexity in crosstalk suppression control.

According to an aspect of the invention, there is provided a method of controlling a plurality of optical switches which are respectively provided between a plurality of input ports and a plurality of output ports and respectively turn on and off the transmission of light from the plurality of the input ports to the plurality of the output ports. The method includes performing a control operation of changing the optical switch from an off state to an on state prior to a control operation of changing the optical switch from the on state to the off state.

According to another aspect of the invention, an optical switch control device includes a control unit that controls a plurality of optical switches which are respectively provided between a plurality of input ports and a plurality of output ports and respectively turn on and off the transmission of light from the plurality of the input ports to the plurality of the output ports. The control unit performs a control operation of changing the optical switch from an off state to an on state prior to a control operation of changing the optical switch from the on state to the off state.

According to still another aspect of the invention, an optical transmission system includes a plurality of optical switches which are respectively provided between a plurality of input ports and a plurality of output ports and respectively turn on and off the transmission of light from the plurality of the input ports to the plurality of the output ports, a control unit that performs a control operation of switching one optical path between an arbitrary input port and an arbitrary output port of the optical switch to another optical path, and a switching unit that changes the on and off states of the optical switch. The switching unit performs a control operation of changing another optical switch corresponding to another optical path from an off state to an on state prior to a control operation of changing the optical switch corresponding to the one optical path from the on state to the off state under the control of the control unit.

An arbitrary combination of the above-mentioned components and a method, a device, a system, a recording medium, and a computer program obtained by converting the expression of the invention are also effective as the aspect of the invention.

Various components of the invention are not necessarily independently provided, but may be configured as follows:

a plurality of components are formed as one member; one component is formed by a plurality of members; a given component is a portion of another component; and a portion of a given component and a portion of another component overlap each other.

A plurality of processes are sequentially described in the method and the computer program according to the invention, but the description order does not limit the order in which the plurality of processes are performed.

Therefore, when the method and the computer program according to the invention are executed, the order of the plurality of processes can be changed within the range in which the content of the processes is not changed.

The plurality of processes in the method and the computer program according to the invention are performed at different times, but the invention is not limited thereto. For example, the processes maybe performed as follows: while a given process is being performed, another process is generated; and the execution time of a given process and the execution time of another process partially or entire overlap each other.

The invention provides an optical switch control method, an optical switch control device, and an optical transmission system capable of suppressing crosstalk with a simple control method.

### BRIEF DESCRIPTION OF THE DRAWINGS

The above and other objects, features, and advantages of the invention will become apparent from the following exemplary embodiments and the accompanying drawings.

FIG. 1 is a schematic diagram illustrating the structure of an optical switch control device according to an exemplary embodiment of the invention.

FIG. 2 is a diagram illustrating the operation of a matrix optical switch according to the exemplary embodiment of the invention.

FIG. 3 is a flowchart illustrating the procedure of the operation of the optical switch control device according to the exemplary embodiment of the invention.

FIG. 4 is a diagram illustrating the operation of the matrix optical switch according to the exemplary embodiment of the invention.

FIG. 5 is a diagram illustrating the operation of the matrix optical switch according to the exemplary embodiment of the invention.

FIG. 6 is a schematic diagram illustrating the structure of an optical switch control device according to an exemplary embodiment of the invention.

FIG. 7 is a diagram illustrating the operation of a matrix optical switch according to the exemplary embodiment of the invention.

FIG. 8 is a schematic diagram illustrating the structure of an optical switch control device according to an exemplary embodiment of the invention.

FIG. 9 is a diagram illustrating the operation of a matrix optical switch according to the exemplary embodiment of the invention.

FIG. 10 is a diagram illustrating the structure of an optical switch of the matrix optical switch according to the exemplary embodiment of the invention.

FIG. 11 is a diagram illustrating the operation of the matrix optical switch according to the exemplary embodiment of the invention.

FIG. 12 is a block diagram illustrating the structure of an optical node system disclosed in a patent document.

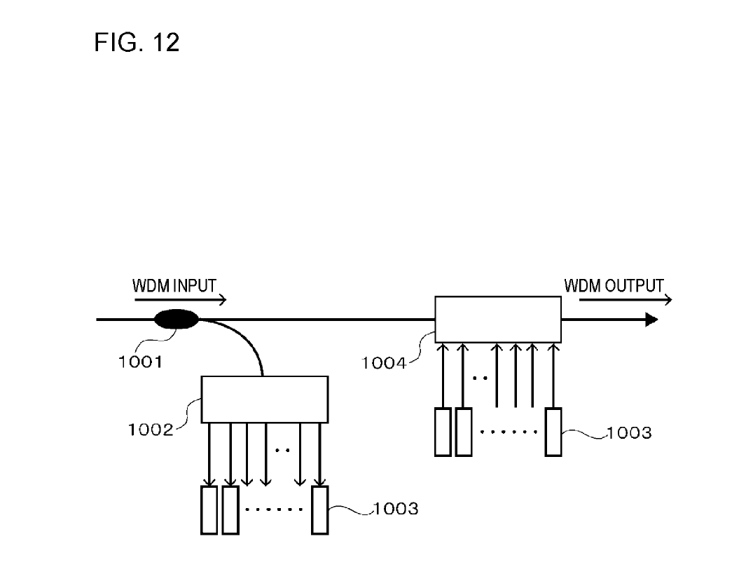

FIG. 13 is a block diagram illustrating an example of the structure of a 1×N drop wavelength selective switch of the optical node system disclosed in the patent document shown in FIG. 12.

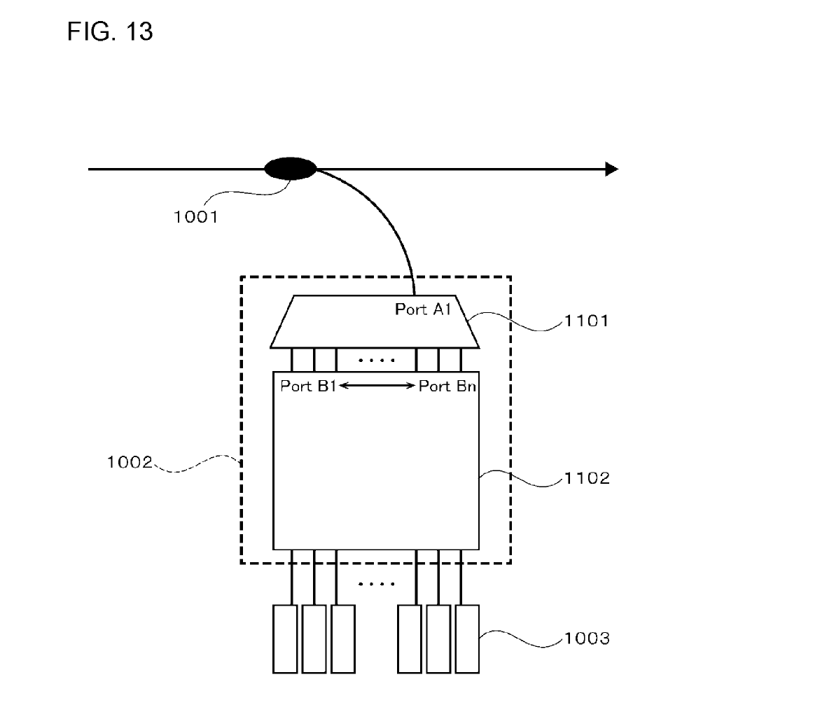

FIG. 14 is a block diagram illustrating an example of the structure of an N×1 add wavelength selective switch of the optical node system disclosed in the patent document shown in FIG. 12.

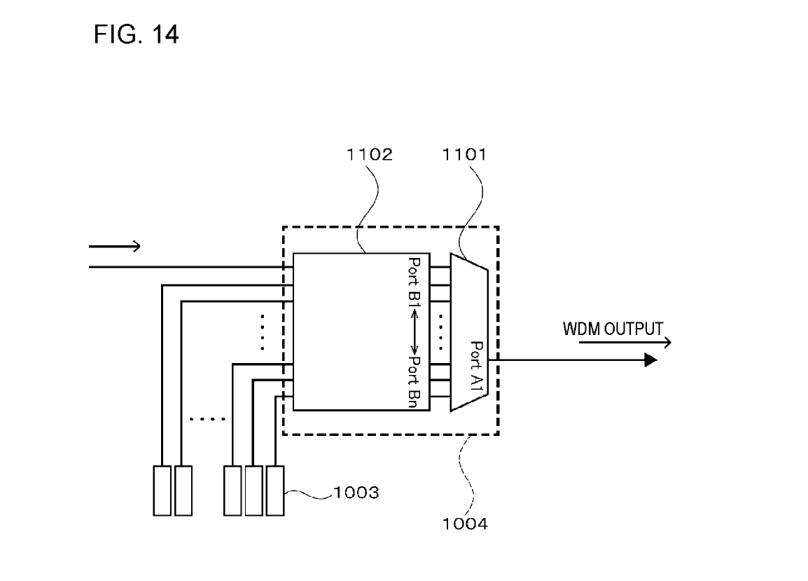

FIG. 15 is a diagram illustrating the structure of a two-dimensional MEMS based matrix optical switch disclosed in a patent document.

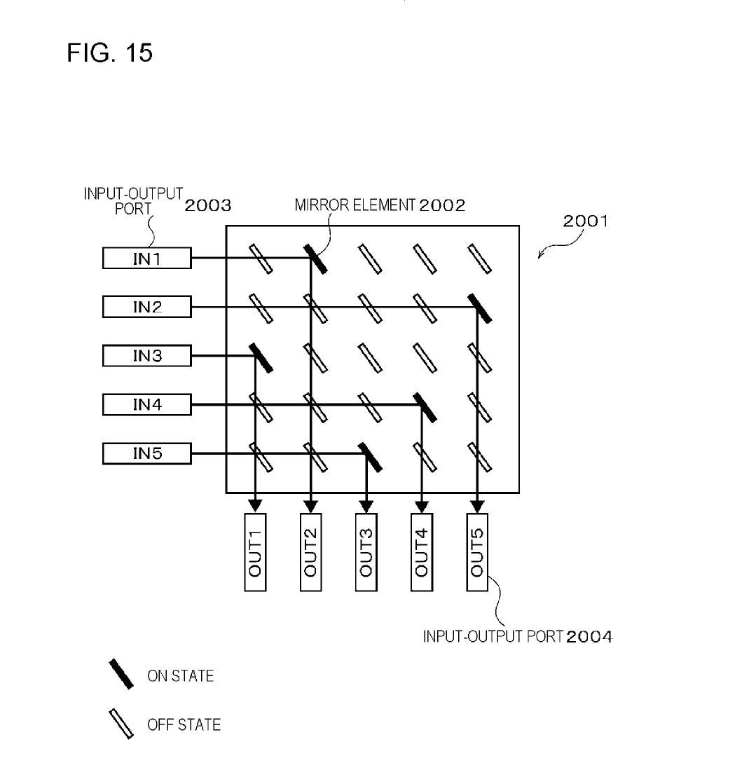

FIG. 16 is a diagram illustrating the structure of a matrix optical switch of a quartz-based optical waveguide disclosed in a patent document.

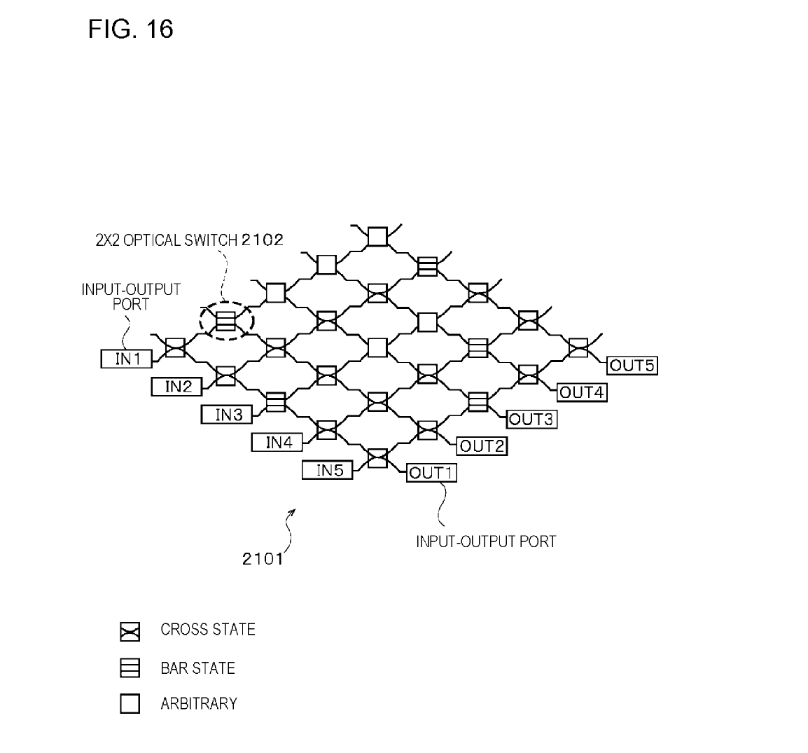

FIG. 17 is a diagram illustrating the concept of crosstalk for a switching period in a matrix optical switch disclosed in a patent document.

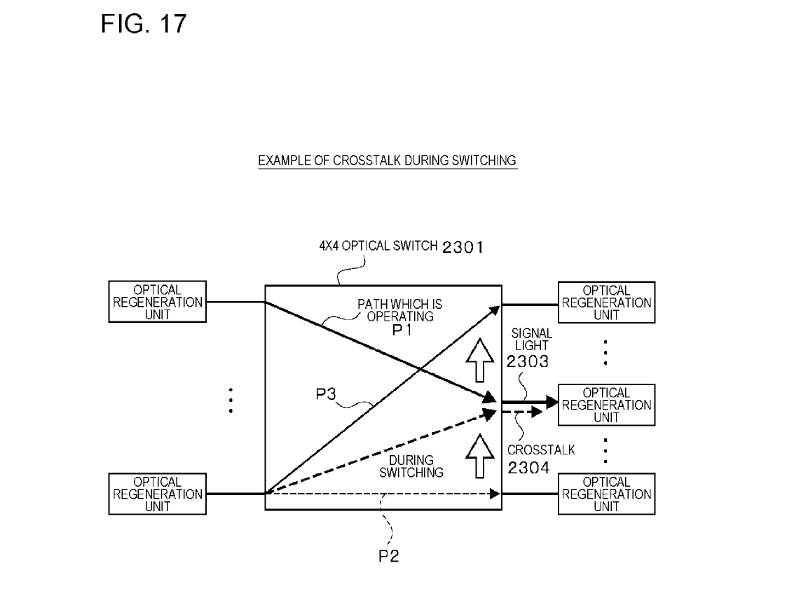

### DESCRIPTION OF EXEMPLARY EMBODIMENTS

Hereinafter, exemplary embodiments of the invention will be described with reference to the accompanying drawings. In all of the drawings, the same constructional elements are denoted by the same reference numerals and the description thereof will not be repeated.

### First Exemplary Embodiment

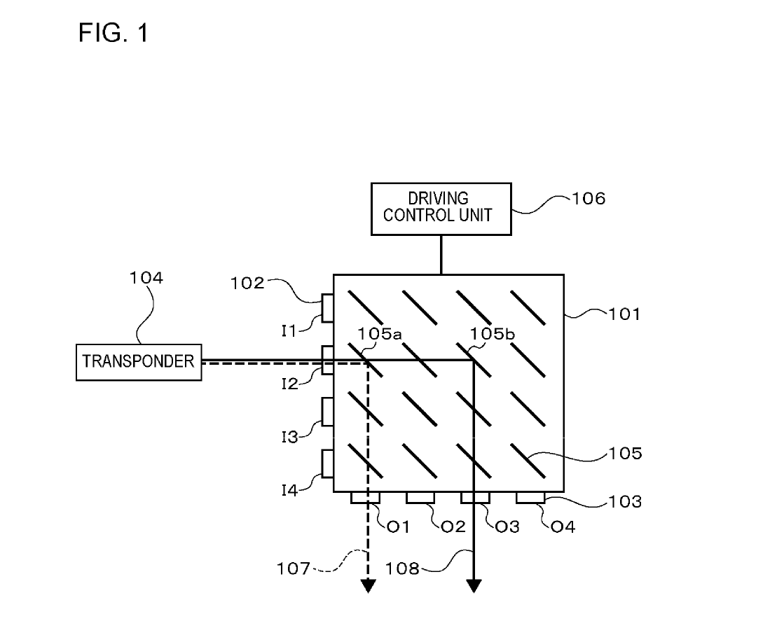

FIG. 1 is a schematic diagram illustrating the structure of an optical switch control device according to an exemplary embodiment of the invention. In FIG. 1, the optical switch control device according to this exemplary embodiment is an example of a matrix optical switch 101 which is arranged on the add side of an add/drop device of an optical node and an OXC/ROADM device (hereinafter, referred to as an optical cross connect device) in a wavelength division multiplexing transmission system.

The optical switch control device according to this exemplary embodiment controls the matrix optical switch 101 provided in the add/drop device of the optical node and the optical cross connect device which transparently switch, branch, or insert an optical signal.

As shown in FIG. 1, the optical switch control device according to the exemplary embodiment of the invention includes a control unit (driving control unit 106) that controls a plurality of optical switches 105 which are respectively provided between a plurality of input ports 102 and a plurality of output ports 103 and respectively turn on and off the transmission of light from the plurality of input ports 102 to the plurality of output ports 103. The driving control unit 106 performs a control operation of changing the optical switch 105 from an off state to an on state prior to a control operation of changing the optical switch 105 from the on state to the off state.

Specifically, the optical switch control device according to this exemplary embodiment includes the driving control unit 106 that controls the matrix optical switch 101.

The driving control unit 106 may be implemented by an arbitrary combination of hardware and software of an arbitrary computer including a Central Processing Unit (CPU), a memory, a program which is loaded to the memory and implements the functions of the constructional elements shown in FIG. 1, a storage unit, such as a hard disk or a Read Only Memory (ROM) storing the program, and a network connection interface. It will be understood by those skilled in the art that various modifications of a method and device for implementing the driving control device can be made. The following drawings do not show the structure of a hardware unit, but show the block of a functional unit.

In the following drawings, the structure of a portion which is not related to the essence of the invention is omitted and is not shown.

In FIG. 1, one driving control unit 106 is shown with respect to one matrix optical switch 101, but the invention is not limited thereto. The driving control unit 106 may control a plurality of matrix optical switches 101 or a plurality of driving control units 106 may control the matrix optical switch 101.

As shown in FIG. 1, the matrix optical switch 101 according to this exemplary embodiment is a two-dimensional MEMS based 4×4 matrix optical switch 101 and includes four input ports I1, I2, I3, and I4 and four output ports O1, O2, O3, and O4.

Here, the term “4×4” means “four inputs and four outputs”.

Since the matrix optical switch 101 according to this exemplary embodiment is arranged in an add unit, respective transponders 104 are connected to the four input ports I1, I2, I3, and I4 in practice. However, in FIG. 1, only the transponder 104 connected to the input port 12 is shown and the other transponders 104 are not shown. The number of ports of the matrix optical switch 101 which is arranged on the add side of the add/drop device of the optical node according to this exemplary embodiment is not limited. An m-input(s) and n-output(s) (m and n are integers) matrix optical switch 101 may be used.

In this exemplary embodiment, the matrix optical switch 101 includes a plurality of optical switches 105. The plurality of optical switches 105 are respectively provided between the plurality of input ports 102 and the plurality of output ports 103 and respectively turn on and off the transmission of light from the plurality of input ports 102 to the plurality of output ports 103. In this exemplary embodiment, the optical switch 105 is a two-dimensional MEMS mirror element, but is not limited thereto. Hereinafter, the optical switch 105 according to this exemplary embodiment is referred to as a mirror element 105.

The two-dimensional MEMS mirror elements 105 are arranged at the intersections of the input ports and the output ports. The mirror element 105 is turned on and off under the control of the driving control unit 106 to transmit or block light from the corresponding input port to the corresponding output port. That is, in the example shown in FIG. 1, the four input ports and the four output ports are connected by 16 MEMS mirror elements 105. A pair of input and output ports is connected by one MEMS mirror element 105 to form an optical path.

The mirror element 105 reflects input light using a plurality of micro mirrors and outputs the light at an arbitrary angle. In this case, for example, when a voltage is applied to an electrode (not shown), the light deflection angle of the mirror element 105 is changed and the mirror element 105 deflects the input light to an arbitrary output port and outputs the light.

Since the basic structure and operation of the mirror element 105 are not limited to the above description and are not related to the essence of the invention, they will not be described. Hereinafter, it is assumed that in this exemplary embodiment, simply, the “turning on and off” of the mirror element 105 is controlled to control the transmission or blocking of light from the input port to the output port of each mirror element 105.

The driving control unit 106 receives control signals from, for example, a remote control device, an optical cross connect device, and an optical node of an optical transmission system (not shown). Then, the driving control unit 106 controls the turning on and off of the mirror elements 105 of the matrix optical switch 101 as described above in response to the received control signals. That is, the driving control unit 106 performs, prior to a control operation of changing one optical switch (mirror element 105a) corresponding to one optical path 107 from an on state to an off state, a control operation of changing another optical switch (mirror element 105b) corresponding to another optical path 108 from an off state to an on state, in response to the received control signal.

When the optical switch (mirror element 105a) is changed from the on state to the off state, the optical signal which passes through the optical path 107 (which is represented by a dashed line in the drawings) formed by the mirror element 105a is blocked. On the other hand, when another optical switch (mirror element 105b) is changed from the off state to the on state, the optical signal passes through the optical path 108 (which is also represented by a record solid line in the drawings) formed by the mirror element 105b. That is, the term “turning on the mirror element” means operating the mirror element such that the light passes through the corresponding optical path and the term “turning off the mirror element” means operating the mirror element to block light passing through the corresponding optical path.

An optical transmission system (not shown) according to the exemplary embodiment of the invention includes the plurality of optical switches 105 which are respectively provided between the plurality of input ports 102 and the plurality of output ports 103 and respectively turn on and off the transmission of light from the plurality of input ports 102 to the plurality of output ports 103, a control unit (for example, remote control device (not shown)) which performs a control operation of switching one optical path 107 between an arbitrary input port 102 and an arbitrary output port 103 of the optical switch 105 to another optical path 108, and a switching unit (driving control unit 106) which changes the on and off states of the optical switch 105. The driving control unit 106 performs, prior to a control operation of changing one optical switch (mirror element 105a) corresponding to one optical path 107 from an on state to an off state, an operation of changing another optical switch (mirror element 105b) corresponding to another optical path 108 from an off state to an on state, under the control of the control unit (for example, a remote control device).

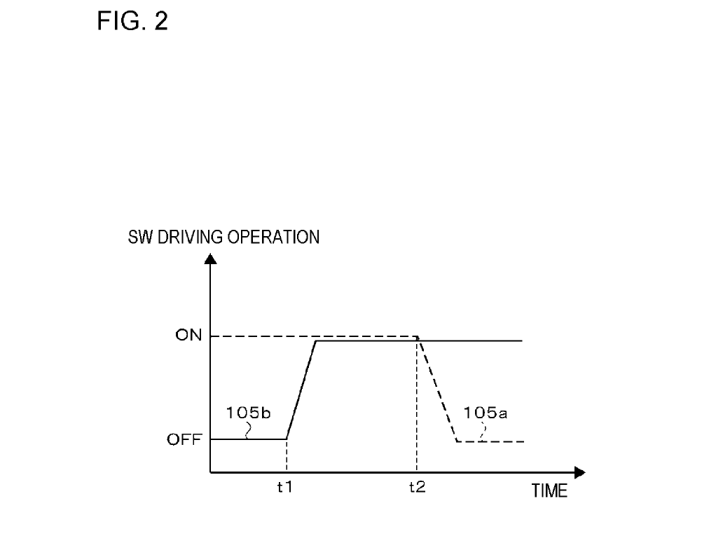

Specifically, as shown in FIG. 2, when the driving control unit 106 receives a control signal for switching the optical path 107 which have been formed before the switching to the optical path 108 which will be formed after the switching, the driving control unit 106 performs an operation of changing the mirror element 105b forming the switched optical path 108 after the switching from an off state to an on state at a time t1 in the driving sequence of the matrix optical switch 101. Then, the driving control unit 106 performs an operation of changing the mirror element 105a forming the optical path 107 before the switching from an on state to an off state at a time t2 after the time t1.

The above-mentioned operation may be implemented by various means. For example, the driving control unit 106 may be formed by, for example, a programmable logic controller and execute a program for performing the above sequence control to implement the above operation. Alternatively, the driving control unit 106 may be formed by, for example, a relay circuit and sequentially perform the above control. Alternatively, the driving control unit 106 may be formed by a semiconductor circuit element and sequentially perform the above control.

Specifically, for example, the driving control unit 106 detects the falling of a control signal for changing the optical switch (mirror element 105a) from an on state to an off state or the rising of a control signal for changing the optical switch (mirror element 105b) from an off state to an on state and operates a delay circuit which delays the output of the control signal to the optical switch (mirror element 105a) by t2−t1, as shown in FIG. 2. It is considered that the driving control unit 106 preferentially supplies a signal for changing the optical switch (mirror element 105b) from an off state to an on state to the optical switch at the time t1.

It is preferable that the control signal received by the driving control unit 106 be transmitted by serial communication. The reason is that, when the matrix optical switch includes a large number of input and output ports and optical switches, the reception of the control signal by parallel communication is likely to cause an increase in the size of the structure and a complicated structure.

The driving control unit 106 may sequentially receive the control signals transmitted by serial communication and perform the above-mentioned control in response to the received control signals.

In the case of serial communication, it is considered that, since a plurality of optical switches are sequentially controlled, a time difference occurs in control between the optical switches. In this exemplary embodiment, it is preferable that the delay time (t2−t1) between the time t1 when the control operation of changing the optical switch from the off state to the on state is performed and the time t2 when the control operation of changing the optical switch from the on state to the off state is performed be set to a range capable of absorbing the time difference between the switches due to the serial communication.

An optical switch control method of the thus configured matrix optical switch 101 in the optical transmission system according to the exemplary embodiment of the invention will be described below.

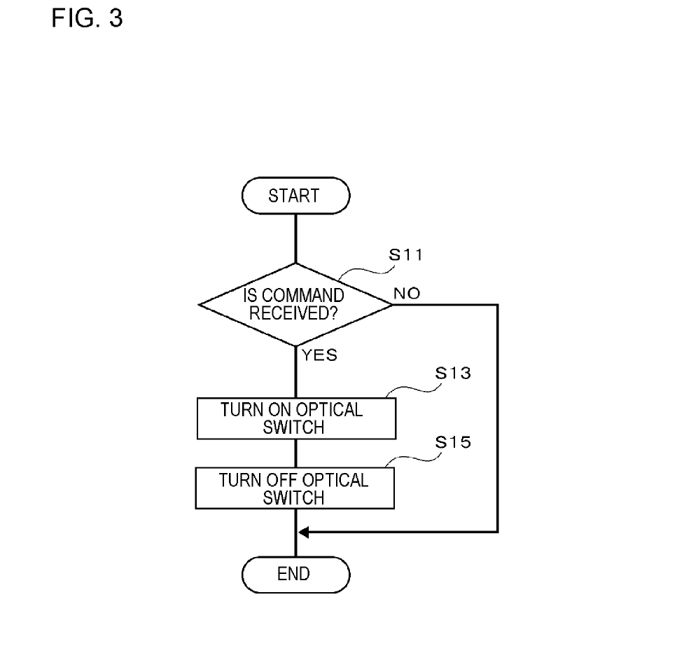

FIG. 3 is a flowchart illustrating the procedure of the operation of the optical switch control device according to the exemplary embodiment of the invention.

The optical switch control method according to this exemplary embodiment is a method of controlling the plurality of optical switches 105 which are respectively provided between the plurality of input ports 102 and the plurality of output ports 103 and respectively turn on and off the transmission of light from the plurality of input ports 102 to the plurality of output ports 103 and performs a control operation of changing the optical switch (mirror element 105b) from an off state to an on state (Step S13) prior to a control operation of changing the optical switch (mirror element 105a) from an on state to an off state (Step S15).

As described above, a computer (CPU) forming the driving control unit 106 of the optical switch control device according to this exemplary embodiment reads the program stored in the storage unit to the memory and performs the procedure including the steps shown in FIG. 3. In this way, the program according to the invention may implement the functions of the driving control unit 106.

Under the assumption that a fault occurs in the transmission path in the two-dimensional matrix optical switch 101, the operation of the matrix optical switch 101 switching the optical path from the optical path 107 to the optical path 108 will be described below as an example of the operation of the optical switch control device according to this exemplary embodiment.

For example, it is assumed that the optical path 107 represented by a dashed line in FIG. 1 is switched to the optical path 108 represented by a solid line due to a fault in the transmission path, such as the disconnection of an optical fiber in an optical transmission path. In this case, the matrix optical switch 101 provided on the add side of the add/drop device of the optical node performs an operation of switching from the mirror element 105a to the mirror element 105b to drive the mirror element 105b.

In this exemplary embodiment, when the remote control device (not shown) receives a Backward Defect Indication (BDI) signal generated from a reception end node (YES in Step S11 of FIG. 3), the driving control unit 106 performs an operation of changing the on and off states of each mirror element 105 of the matrix optical switch 101.

The following two operations are needed in order to switch the transmission path of light from the transponder 104 from the optical path 107 represented by the dashed line to the optical path 108 represented by the solid line. One operation turns off the mirror element 105a forming the optical path 107 which is represented by the dashed line and transmits the light supplied from the transponder 104 from the input port 102 (the input port 12 in FIG. 1) to the output port 103 (the output port O1 in FIG. 1). The other operation turns on the mirror element 105b forming the optical path 108 which is represented by the solid line and transmits the light supplied from the transponder 104 from the input port 102 (the input port 12 in FIG. 1) to the output port 103 (the output port O3 in FIG. 1).

In this exemplary embodiment, a command to turn off the mirror element 105a forming the optical path 107 represented by the dashed line and a command to turn on the mirror element 105b forming the optical path 108 represented by the solid line are simultaneously or sequentially input from the remote control device to the driving control unit 106 of the matrix optical switch 101.

The commands input from the remote control device to the driving control unit 106 may have a format of a combination of the command to turn off the mirror element and the command to turn on the mirror element and the format may be predetermined between the remote control device and the driving control unit 106. For example, the commands to control the mirror element may be defined so as to have a parameter for designating the mirror element to be turned on and a parameter for designating the mirror element to be turned off.

When only the command to turn off the mirror element is input, the driving control unit 106 may wait for the input of a command to turn on another mirror element for a predetermined period of time, confirm that the command to turn on another mirror element is not input, and then execute only the command to turn off the mirror element. Alternatively, before the command to turn off the mirror element is executed, the driving control unit 106 may inquire the remote control device about another mirror element to be turned on instead of the mirror element.

When only the command to turn on one mirror element is input, the process of turning off another mirror element may be automatically performed with respect to the optical path which should be formed by the one mirror element and which has been formed by the another mirror element before the switching.

The method of controlling the optical switch according to the exemplary embodiment of the invention preferentially controls a control operation of changing the mirror element 105b from an off state to an on state. That is, first, the driving control unit 106 processes a command to turn on the mirror element 105b forming the optical path 108 represented by the solid line in response to the command from the remote control device (Step S13 in FIG. 3). Then, the driving control unit 106 processes a command to turn off the mirror element 105a forming the optical path 107 represented by the dashed line (Step S15 in FIG. 3).

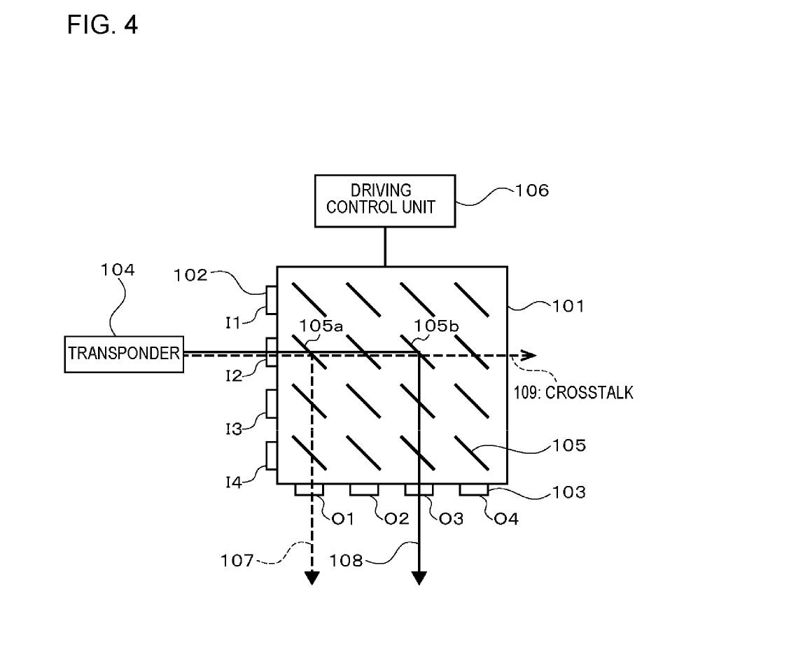

When the command to turn off the mirror element 105a forming the optical path 107 represented by the dashed line is preferentially processed, the light traveling along the optical path 107 represented by the dashed line is likely to be emitted in the right direction of FIG. 4 for a switching time until the mirror element 105b forming the optical path 108 represented by the solid line is turned on, as shown in FIG. 4. The light emitted along the optical path is likely to intersect the optical signal in service and to cause crosstalk 109.

As described above, in the optical switch control device according to the exemplary embodiment of the invention, the driving control unit 106 can preferentially control the switching of the driving sequence of the matrix optical switch 101 from an off state to an on state.

Therefore, for the switching period, the light which travels along the optical path before switching does not affect other optical paths. As a result, it is possible to suppress the occurrence of crosstalk.

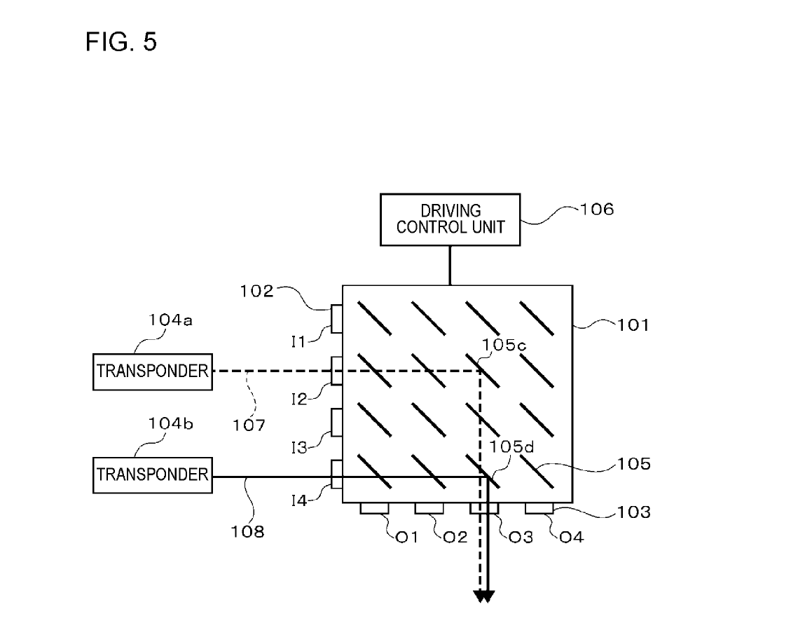

Next, under the assumption that a failure in the transponder 104 or a fault in the transmission path, such as the disconnection of an optical fiber in the optical transmission path to the transponder 104 occurs in the matrix optical switch 101 according to this exemplary embodiment, the operation will be described with reference to FIG. 5. In particular, the operation of the matrix optical switch 101 switching from the optical path 107 before the switching to the optical path 108 after the switching with switching from the transponder 104a to the transponder 104b will be described below.

As shown in FIG. 5, when a fault occurs, the driving control unit 106 receives a command from the remote control device. Here, a command to switch the optical path 107 represented by the dashed line to the optical path 108 represented by the solid line is received in order to switch from the transponder 104a to the transponder 104b. The driving control unit 106 controls an operation of switching the mirror element 105c to the mirror element 105d to drive the mirror element 105d in the matrix optical switch 101 which is arranged on the add side of the add/drop device of the optical node, in response to receipt of the command.

In the method of controlling the optical switch according to the exemplary embodiment of the invention, the driving control unit 106 preferentially controls an operation of changing the mirror element 105d from an off state to an on state. That is, the driving control unit 106 processes a command to turn on the mirror element 105d forming the optical path 108 represented by the solid line in advance and then processes a command to turn off the mirror element 105c forming the optical path 107 represented by the dashed line, in response to the commands received from the remote control device.

For example, a situation in which the intensity of light input from the transponder 104a is low, but the light is not completely shielded is considered. In this situation, when the command to turn off the mirror element 105c forming the optical path 107 represented by the dashed line is performed in advance, the light which travels along the optical path 107 represented by the dashed line is likely to be emitted in the right direction of FIG. 5 for the switching time until the mirror element 105d forming the optical path 108 represented by the solid line is turned on. The emitted light is likely to intersect the optical signal in service and to cause the crosstalk 109 (not shown in FIG. 5).

As described above, in the optical switch control device according to the exemplary embodiment of the invention, when a fault occurs, for example, a failure occurs in the transponder 104 which is arranged on the add side of the add/drop device of the optical node in the wavelength division multiplexing transmission system, the driving control unit 106 can preferentially control an operation of changing the driving sequence of the matrix optical switch 101 from an off state to an on state. Therefore, for the switching period, the light which travels through the optical path before switching does not affect other optical paths. As a result, it is possible to suppress the occurrence of crosstalk.

### Second Exemplary Embodiment

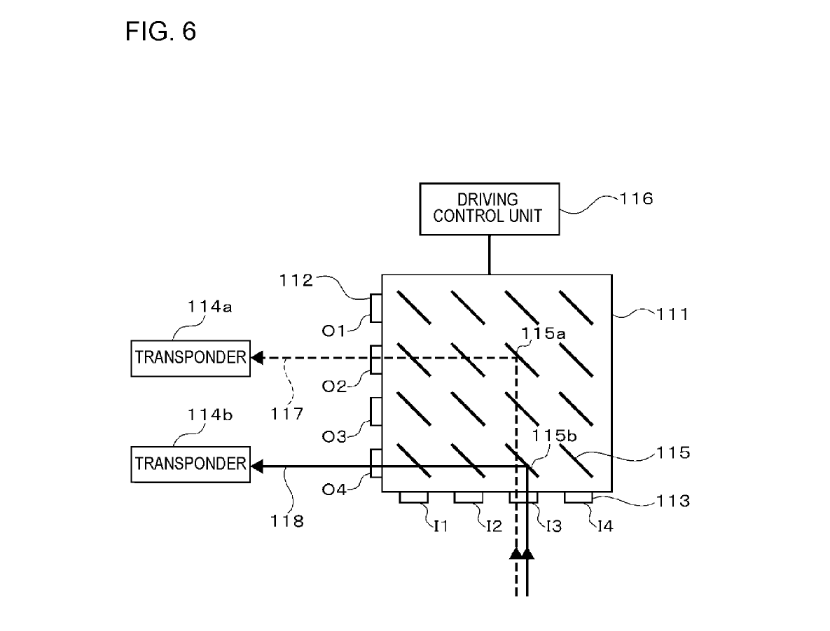

FIG. 6 is a schematic diagram illustrating the structure of an optical switch control device according to an exemplary embodiment of the invention. In FIG. 6, the optical switch control device according to this exemplary embodiment is an example of a matrix optical switch 111 which is provided on the drop side of an add/drop device of an optical node and an optical cross connect device in a wavelength division multiplexing transmission system.

The optical switch control device according to this exemplary embodiment differs from that according to the above exemplary embodiment in that the matrix optical switch 111 is provided on the drop side. An optical switch (mirror element) 115 according to this exemplary embodiment is the same as the optical switch (mirror element) 105 according to the above exemplary embodiment.

As shown in FIG. 6, the optical switch control device (matrix optical switch 111) according to the exemplary embodiment of the invention includes a control unit (driving control unit 116) that controls the turning on and off of a plurality of optical switches 115. The plurality of optical switches 115 are respectively provided between a plurality of input ports 113 and a plurality of output ports 112 and respectively turn on and off the transmission of light from the plurality of input ports 113 to the plurality of output ports 112. The driving control unit 116 performs a control process of changing the optical switch 115 from an off state to an on state prior to a control operation of changing the optical switch 115 from the on state to the off state.

Specifically, the optical switch control device according to this exemplary embodiment includes a driving control unit 116 which controls the matrix optical switch 111.

As shown in FIG. 6, the matrix optical switch 111 according to this exemplary embodiment is a two-dimensional MEMS based 4×4 matrix optical switch 111 and includes four input ports I1, I2, I3, and I4 and four output ports O1, O2, O3, and O4.

Since the matrix optical switch 111 according to this exemplary embodiment is arranged on the drop side, the respective transponders 114 are connected to the four output ports O1, O2, O3, and O4 in practice. However, in FIG. 6, only two transponders 114a and 114b respectively connected to two output ports O2 and O4 are shown and the other transponders 114 are not shown. The number of ports of the matrix optical switch 111 which is arranged on the drop side of the add/drop device of the optical node according to this exemplary embodiment is not limited. An m-input(s) and n-output(s) (m and n are integers) matrix optical switch 111 may be used.

The two-dimensional MEMS mirror elements 115 are arranged at the intersections of the input ports and the output ports and are turned on and off under the control of the driving control unit 116 to transmit or block light from the corresponding input ports to the corresponding to output ports.

The driving control unit 116 receives control signals from, for example, a remote control device, an optical cross connect device, and an optical node of an optical transmission system (not shown) and controls the turning on and off of the mirror elements 115 of the matrix optical switch 111 in response to the received control signals, similarly to the driving control unit 106 according to the aforementioned exemplary embodiment.

Similarly to the aforementioned exemplary embodiment shown in FIG. 3, an optical switch control method according to this exemplary embodiment is a method of controlling a plurality of optical switches which are respectively provided between the plurality of input ports 113 and the plurality of output ports 112 and respectively turn on and off the transmission of light from the plurality of input ports 113 to the plurality of output ports 112 and performs a control operation of changing the optical switch (mirror element 115b) from an off state to an on state (Step S13 in FIG. 3) prior to a control operation of changing the optical switch (mirror element 115a) from an on state to an off state (Step S15 in FIG. 3).

Here, under the assumption that a failure in the transponder 104 or a fault in a transmission path, such as the disconnection of an optical fiber in the optical transmission path to the transponder 114 occurs in the matrix optical switch 101 according to this exemplary embodiment, the operation will be described. In particular, the operation of the matrix optical switch 111 switching from an optical path 117 before the switching to an optical path 118 after the switching with switching from the transponder 114a to the transponder 114b will be described below.

As shown in FIG. 6, when a fault occurs, the driving control unit 116 receives a command from the remote control device. The driving control unit 116 receives a command to switch the optical path 117 represented by a dashed line to the optical path 118 represented by a solid line in order to switch from the transponder 114a to the transponder 114b. In response to receipt of the command, the driving control unit 116 controls an operation for switching from the mirror element 115a to the mirror element 115b to drive the mirror element 115b in the matrix optical switch 111 which is arranged on the drop side of the add/drop device of the optical node.

In the optical switch control method according to the exemplary embodiment of the invention, the driving control unit 116 preferentially controls an operation of changing the mirror element 115b from an off state to an on state. That is, the driving control unit 116 processes a command to turn on the mirror element 115b forming the optical path 118 represented by the solid line in advance and then processes a command to turn off the mirror element 115a forming the optical path 117 represented by the dashed line, in response to the commands received from the remote control device.

When the command to turn off the mirror element 115a forming the optical path 117 represented by the dashed line is preferentially processed, the light which travels along the optical path 117 represented by the dashed line is likely to be emitted in the upward direction (not shown) of FIG. 6 for a switching time until the mirror element 115b forming the optical path 118 represented by the solid line is turned on. The emitted light is likely to intersect the optical signal in service and to cause crosstalk.

As described above, in the optical switch control device according to the exemplary embodiment of the invention, when a fault occurs, for example, a failure occurs in the transponder 114 which is arranged on the drop side of the add/drop device of the optical node in the wavelength division multiplexing transmission system, the driving control unit 116 can preferentially control an operation of changing the driving sequence of the matrix optical switch 111 from an off state to an on state. Therefore, for the switching period, the light which travels along the optical path before switching does not affect other optical paths. As a result, it is possible to suppress the occurrence of crosstalk.

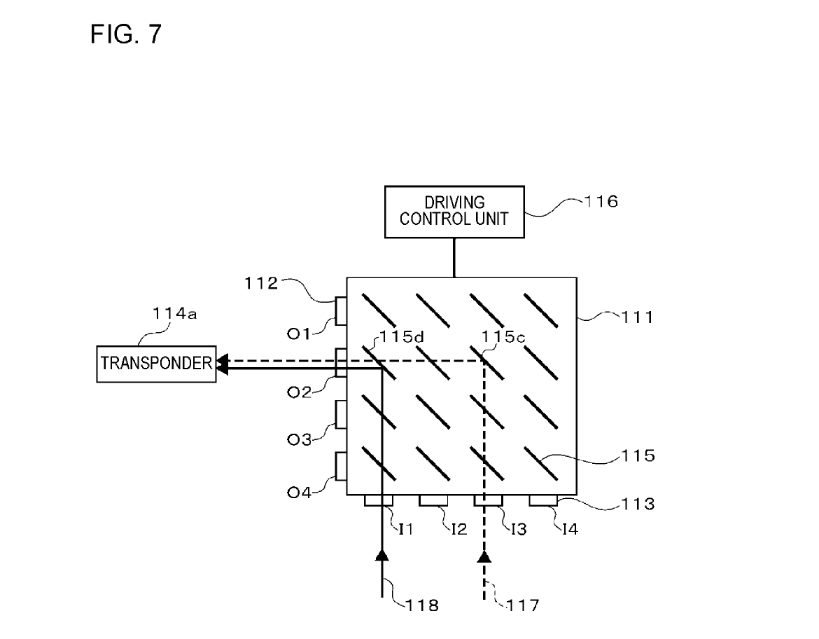

Next, under the assumption that a fault in the transmission path, such as the disconnection of an optical fiber occurs in the optical transmission path, the operation of the matrix optical switch 111 according to this exemplary embodiment will be described with reference to FIG. 7. In particular, the operation of the matrix optical switch 111 switching the optical path 117 before the switching to the optical path 118 after the switching will be described below.

As shown in FIG. 7, when a fault occurs, the driving control unit 116 receives a command from the remote control device. A command to switch the optical path 117 represented by the dashed line to the optical path 118 represented by the solid line is received. The driving control unit 116 controls an operation for switching a mirror element 115c to a mirror element 115d to drive the mirror element 115d in the matrix optical switch 111 which is arranged on the drop side of the add/drop device of the optical node, in response to receipt of the command.

In the method of controlling the optical switch according to the exemplary embodiment of the invention, the driving control unit 116 preferentially controls an operation of changing the mirror element 115d from an off state to an on state. That is, the driving control unit 116 processes a command to turn on the mirror element 115d forming the optical path 118 represented by the solid line in advance and then processes a command to turn off the mirror element 115c forming the optical path 117 represented by the dashed line, in response to the command received from the remote control device.

For example, a situation in which the intensity of light input from the input port 13 of the matrix optical switch 111 is low, but the light is not completely shielded is considered. In this situation, when the command to turn off the mirror element 115c forming the optical path 117 represented by the dashed line is performed in advance, the light which travels along the optical path 117 represented by the dashed line is likely to be emitted in the upward direction (not shown) of FIG. 7 for the switching time until the mirror element 115d forming the optical path 118 represented by the solid line is turned on. The emitted light is likely to intersect the optical signal in service and to cause the crosstalk.

As described above, in the optical switch control device according to the exemplary embodiment of the invention, when a fault occurs, for example, a failure occurs in the transponder 114 which is arranged on the drop side of the add/drop device of the optical node in the wavelength division multiplexing transmission system, the driving control unit 116 can preferentially control an operation of changing the driving sequence of the matrix optical switch 111 from an off state to an on state. Therefore, for the switching period, the light which travels along the optical path before switching does not affect other optical paths. As a result, it is possible to suppress the occurrence of crosstalk.

### Third Exemplary Embodiment

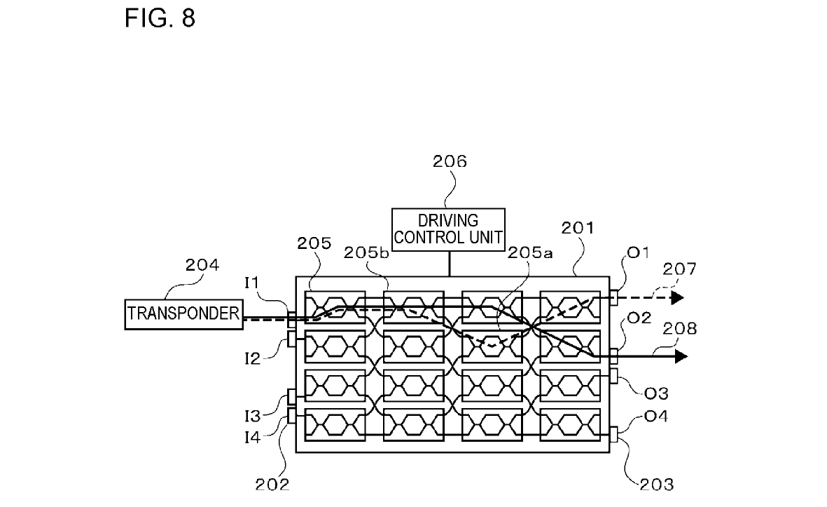

FIG. 8 is a schematic diagram illustrating the structure of an optical switch control device according to an exemplary embodiment of the invention. In FIG. 1, the optical switch control device according to this exemplary embodiment is an example of a matrix optical switch 201 which is arranged on the add side of an add/drop device of an optical node and an optical cross connect device in a wavelength division multiplexing transmission system.

The optical switch control device according to this exemplary embodiment differs from the optical switch control devices according to the aforementioned exemplary embodiments in that the matrix optical switch 201 is integrated onto a Planar Lightwave Circuit (PLC).

As shown in FIG. 8, the optical switch control device (matrix optical switch 201) according to the exemplary embodiment of the invention includes a control unit (driving control unit 206) which controls the turning on and off of a plurality of optical switches 205. The plurality of optical switches 205 are respectively provided between a plurality of input ports 202 and a plurality of output ports 203 and respectively turn on and off the transmission of light from the plurality of input ports 202 to the plurality of output ports 203. The driving control unit 206 performs a control operation of changing the optical switch 205 from an off state to an on state prior to a control operation of changing the optical switch 205 from the on state to the off state.

Specifically, the optical switch control device according to this exemplary embodiment includes the driving control unit 206 which controls the matrix optical switch 201.

As shown in FIG. 8, the matrix optical switch 201 according to this exemplary embodiment is integrated onto the Planar Lightwave Circuit (PLC) and includes four input ports I1, I2, I3, and I4 and four output ports O1, O2, O3, and O4.

The matrix optical switch 201 according to this exemplary embodiment may be an element of a device in which a plurality of functions, for example, a mechanical component, a sensor, an actuator, and a circuit are integrated onto a substrate, such as a silicon substrate or a glass substrate. For example, the matrix optical switch 201 is an example of an element of a semiconductor integrated circuit.

Since the matrix optical switch 201 according to this exemplary embodiment is arranged on the add side, respective transponders 204 are connected to the four input ports I1, I2, I3, and I4. However, in FIG. 8, only the transponder 204 connected to the input port I1 is shown, but the other transponders 204 are not shown. The number of ports of the matrix optical switch 201 which is arranged on the add side of the add/drop unit of the optical node according to this exemplary embodiment is not limited. An m-input(s) and n-output(s) (m and n are integers) matrix optical switch 201 may be used.

The matrix optical switch 201 according to this exemplary embodiment includes 2×2 optical switches 205 as basic constructional elements and thus constructs a matrix optical switch including a plurality of input and output ports. The term “2×2” means “two inputs and two outputs”.

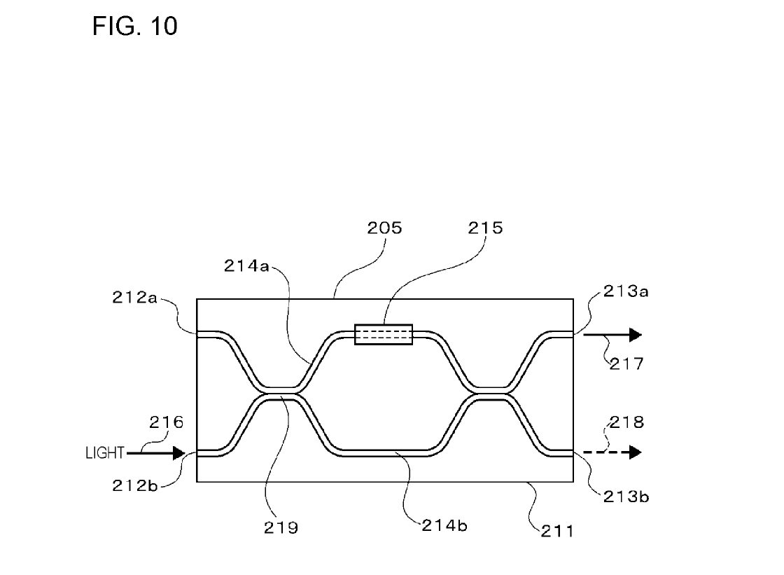

As shown in FIG. 10, the 2×2 optical switches 205 have a Mach-Zehnder Interferometer (MZI) structure. The optical switch 205 includes two input terminals 212a and 212b and two output terminals 213a and 213b on a glass substrate 211.

Two-way waveguides 214a and 214b are formed on the glass substrate 211 and input light 216 which is input from one of the input terminals 212a and 212b is branched at a coupler 219, which is a branch point, and then travels along the waveguides 214a and 214b.

Specifically, for example, an electrode (thin film heater 215) is provided at one waveguide, for example, the waveguide 214a in FIG. 10. When a current application unit (not shown) applies a current to the thin film heater 215, the temperature of the waveguide varies. The refractive index of the waveguide is changed by the thermo-optical effect to shift the phase of light. In this way, an on/off switching operation is implemented. As such, the turning on and off of the application of the current to the thin film heater 215 is controlled to switch the waveguides through which the input light 216 travels. That is, a current is applied to drive the optical switch 205 according to this exemplary embodiment.

For example, when the input light 216 is input to one input terminal, for example, the input terminal 212b in FIG. 10, the input light 216 travels through the waveguide 214a and the waveguide 214b through the coupler 219. The optical switch 205 is configured such that, when no current is applied to the thin film heater 215 (off state), the input light 216 is output output light 217 from the output terminal 213a. On the other hand, the optical switch 205 is configured such that, when a current applied to the thin film heater 215 (on state), the input light 216 is output output light 218 from the output terminal 213b.

That is, when the optical switch 205 is turned on under the control of the driving control unit 116, a current is applied to the thin film heater 215 and the input light 216 is output as the output light 218 from the output terminal 213b. On the other hand, when the control of turning off is performed by the driving control unit 116, no current applied to the thin film heater 215 and the input light 216 is output as the output light 217 from the output terminal 213a.

Returning to FIG. 8, in this exemplary embodiment, the matrix optical switch 201 has a structure in which four input ports and four output ports are connected by 16 2×2 optical switches 205. A pair of input and output ports are connected to each other by the on operation of one 2×2 optical switch 205. One optical path is formed by a pair of input and output ports.

For example, in FIG. 8, when the light which is input from the transponder 204 to the input port I1 is output from the output port O1 (an optical path 207 in FIG. 8), the optical switch 205a is controlled to be turned on. When the light which is input from the transponder 204 to the input port I1 is output from the output port O2 (an optical path 208 in FIG. 8), the optical switch 205b is controlled to be turned on.

The driving control unit 206 receives control signals from, for example, a remote control device, an optical cross connect device, and an optical node of an optical transmission system (not shown) and controls the turning on and off of the optical switches 205 of the matrix optical switch 201 in response to the received control signals.

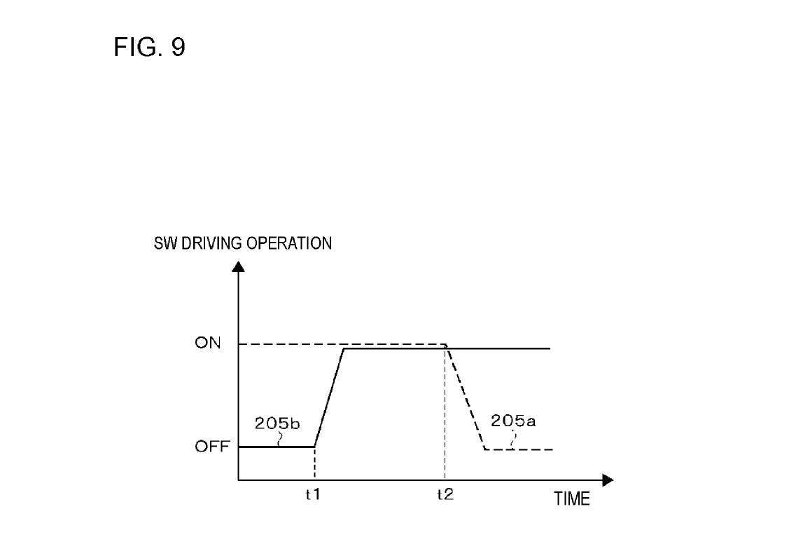

Specifically, as shown in FIG. 9, when receiving a control signal for switching the optical path 207 before the switching to the optical path 208 after the switching, the driving control unit 206 performs an operation of changing the optical switch 205b forming the switched optical path 208 after the switching from an off state to an on state at a time t1 in the driving sequence of the matrix optical switch 201. Then, the driving control unit 206 performs an operation of changing the optical switch 205a forming the optical path 108 before the switching from an on state to an off state at a time t2 after the time t1.

An optical switch control method of the thus configured matrix optical switch 201 in the optical transmission system according to the exemplary embodiment of the invention includes a processing similar to that of the aforementioned exemplary embodiments.

The optical switch control method according to this exemplary embodiment is the same as that according to the aforementioned exemplary embodiments shown in FIG. 3, is a method of controlling a plurality of optical switches which are respectively provided between the plurality of input ports 202 and the plurality of output ports 203 and respectively turn on and off the transmission of light from the plurality of input ports 202 to the plurality of output ports 203, and performs a control operation of changing the optical switch 205b from an off state to an on state (Step S13 in FIG. 3) prior to a control operation of changing the optical switch 205a from an on state to an off state (Step S15 in FIG. 3).

The operation under the assumption that a fault in a transmission path occurs in the matrix optical switch 201 will be described as an example of the operation of the optical switch control device according to this exemplary embodiment. In particular, the operation of the matrix optical switch 201 switching the optical path 207 to the optical path 208 will be described below.

When the optical path 207 represented by the dashed line is switched to the optical path 208 represented by the solid line due to a fault in the transmission path, such as the disconnection of an optical fiber in the optical transmission path, the matrix optical switch 201 which is arranged on the add side of the add/drop device of the optical node performs an operation for switching the optical switch 205a to the optical switch 205b to drive the optical switch 205b.

In this case, in this exemplary embodiment, the driving control unit 206 processes a command to turn on the optical switch 205b forming the optical path 208 represented by the solid line in advance and then processes a command to turn off the optical switch 205a forming the optical path 207 represented by the dashed line in response to the command from the remote control device.

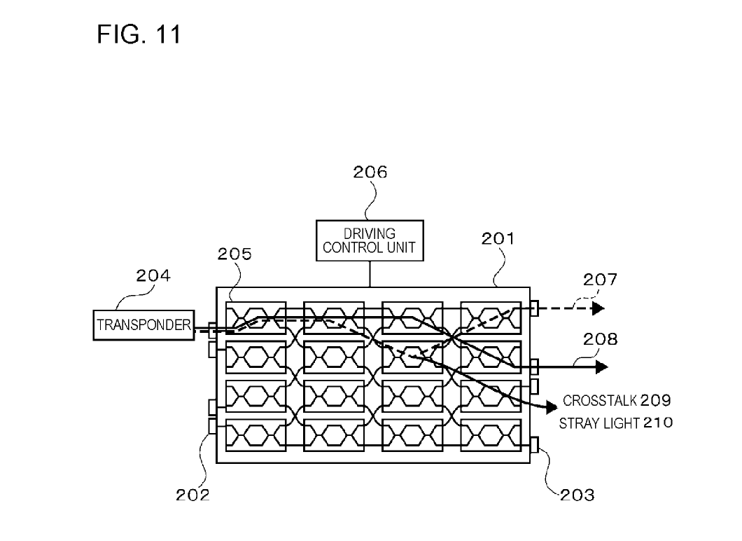

When the command to turn off the optical switch 205a forming the optical path 207 represented by the dashed line (FIG. 8) is preferentially processed, the light which travels along the optical path 207 represented by the dashed line is likely to be emitted in the right direction of FIG. 11 for a switching time until the optical switch 205b forming the optical path 208 represented by the solid line (FIG. 8) is turned on, as shown in FIG. 11. The emitted light is likely to intersect the optical signal in service and to cause crosstalk 209, or the light is likely to be emitted into the glass substrate 211 (FIG. 10) and to become stray light 210.

In this exemplary embodiment, the case in which a fault occurs in the transmission path in the optical node side, using the matrix optical switch 201 which is arranged on the add side of the add/drop device as an example has been described. However, in this exemplary embodiment, the similar operation may be performed even in the case in which a fault occurs on the transponder side similarly to the matrix optical switch 101 and the matrix optical switch 111 according to the aforementioned exemplary embodiments or even in the case in which a fault occurs on the optical node side or the transponder side with respect to the matrix optical switch provided on the drop side of the add/drop device. In those cases, the similar effect may be also obtained.

As described above, according to the optical switch control device of the exemplary embodiment of the invention, the driving control unit 206 can preferentially control an operation of changing the driving sequence of the matrix optical switch 201 from an off state to an on state.

Therefore, for the switching period, the light which travels along the optical path before switching does not affect the other optical paths. As a result, it is possible to suppress the occurrence of crosstalk and stray light.

In this exemplary embodiment, the case in which a fault occurs in the transmission path in the optical node side, using the matrix optical switch 201 which is arranged on the add side of the add/drop device as an example has been described. However, in this exemplary embodiment, the similar operation may be performed even in the case in which a fault occurs on the transponder side similarly to the matrix optical switch 101 and the matrix optical switch 111 according to the aforementioned exemplary embodiments or even in the case in which a fault occurs on the optical node side or the transponder side with respect to the matrix optical switch provided on the drop side of the add/drop device. In those cases, the similar effect may be also obtained.

The exemplary embodiments of the invention have been described above with reference to the drawings. However, the exemplary embodiments are illustrative examples of the invention and may have various structures other than the above.

For example, it is preferable that the matrix optical switches according to the exemplary embodiments of the invention have a non-blocking structure in which the paths of the signals from each input port do not collide with each other. The non-blocking structure means a structure in which lights can be simultaneously input and output through all of the input and output ports.

The matrix optical switch according to each of the exemplary embodiments of the invention is characterized in that it is a functional block with a connection function of switching an optical signal from an arbitrary path to an arbitrary path. The matrix optical switch according to each of the exemplary embodiments of the invention may be provided in, for example, the add/drop device of the optical node and the optical cross connect device in the wavelength division multiplexing transmission system, and the applications of the optical switch are not particularly limited.

In the above-described exemplary embodiments, the control signals which are received by the driving control unit from, for example, the remote control device, the optical cross connect device, and the optical node in the optical transmission system include a command to directly change the optical switches, such as a command to turn on and off the optical switch or a command to designate the optical path to be switched. In addition, in another exemplary embodiment, as the control signal to the driving control unit, a signal indicating operation status information including information about a fault in the optical node or the transponder connected to the optical switch or the transmission path may be received as an instruction to switch the optical switch and the optical switch may be switched on the basis of the signal.

For example, a signal indicating that the optical node connected to the optical switch operates normally and a signal for driving the optical switch corresponding to the input and output ports connected to this optical node may be connected to the optical switch through an AND circuit, and the optical switch then may use the signal for controlling the turning on of the optical switch, thereby controlling the turning on and off of the optical switch.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2011-132648, filed Jun. 14, 2011, the disclosure of which is incorporated herein in its entirety by reference.

What is claimed is:

1. A method of controlling a plurality of optical switches which are respectively provided between a plurality of input ports and a plurality of output ports and respectively turn on and off the transmission of light from the plurality of said input ports to the plurality of said output ports, comprising:
performing a control operation of changing said optical switch from an off state to an on state prior to a control operation of changing said optical switch from the on state to the off state.

2. The method of controlling the optical switches according to claim 1, further comprising:
receiving a control signal for switching one optical path between an arbitrary input port and an arbitrary output port to another optical path; and
performing a control operation of changing another optical switch corresponding to said another optical path from the off state to the on state prior to a control operation of changing an optical switch corresponding to said one optical path from the on state to the off state, in response to the received control signal.

3. The method of controlling the optical switches according to claim 2, further comprising:
receiving, in sequential order, said control signal which is transmitted by serial communication; and
performing said control operation of switching said optical path to said another optical path in response to the received control signal.

4. An optical switch control device comprising:
a control unit that controls a plurality of optical switches which are respectively provided between a plurality of input ports and a plurality of output ports and respectively turn on and off the transmission of light from the plurality of said input ports to the plurality of said output ports,
wherein said control unit performs a control operation of changing said optical switch from an off state to an on state prior to a control operation of changing said optical switch from the on state to the off state.

5. The optical switch control device according to claim 4, further comprising:
a receiving unit that receives a control signal for switching one optical path between an arbitrary input port and an arbitrary output port to another optical path,
wherein the control unit performs a control operation of changing another optical switch corresponding to said another optical path from the off state to the on state prior to a control operation of changing one optical switch corresponding to said one optical path from the on state to the off state, in response to the received control signal.

6. The optical switch control device according to claim 5,
wherein said receiving unit sequentially receives the control signal which is transmitted by serial communication, and
said control unit performs said control operation of switching said one optical path to said another optical path in response to the received control signal.

7. The optical switch control device according to claim 4,
wherein said optical switch is an optical switch which is formed by a Planar Lightwave Circuit (PLC) or a Micro Electro Mechanical System (MEMS).

8. The optical switch control device according to claim 7,
wherein said optical switch formed by said planar lightwave circuit is driven by the application of a current.

9. The optical switch control device according to claim 7,
wherein said optical switch formed by said planar lightwave circuit is an element on a board into which a plurality of functions are integrated.

10. An optical transmission system comprising:
a plurality of optical switches which are respectively provided between a plurality of input ports and a plurality of output ports and respectively turn on and off transmission of light from the plurality of said input ports to the plurality of said output ports;
a control unit that performs a control operation of switching one optical path between an arbitrary input port and an arbitrary output port of the optical switch to another optical path; and
a switching unit that changes the on and off states of said optical switch,
wherein said switching unit performs a control operation of changing another optical switch corresponding to said another optical path from an off state to an on state prior to a control operation of changing the optical switch corresponding to said one optical path from the on state to the off state under the control of said control unit.
